(19) United States
(12) Patent Application Publication
(10) Pub. No.: US 2010/0202644 A1
(43) Pub. Date: Aug. 12, 2010

(54) BATTERY LOCK

(75) Inventors: Jan Angst, Horgen (CH); Erich Dittli, Reichenburg (CH); Paul Portmann, Schindellegi (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/676,187

(22) PCT Filed: Sep. 5, 2007
(86) PCT No.: PCT/EP07/59295

§ 371 Date: Mar. 3, 2010

(51) Int. Cl. H04R 25/00

(52) U.S. Cl. 381/323

(57) ABSTRACT

Smallest electronic device such as e.g. a hearing instrument being operated by means of a battery which comprises a battery compartment (1) or the at least one battery (3) for power supply of the device. The battery (3) is locked in the compartment (2) to prevent removal or falling out of the battery.

The present invention refers to smallest electronic devices, such as e.g. hearing aids being operated by means of batteries, such as e.g. so called button batteries.

Smallest electronic devices such as hearing instruments may be operated with batteries such as e.g. zinc-air batteries. In order to avoid children eating the batteries of hearing instruments, different solutions of tamper proof battery compartments are on the market.

A tamper-resistant battery drawer is mostly solved as locking mechanism, which does not allow opening the battery compartment in the locked position. Different solutions are possible with mechanical parts, which have to be locked or unlocked with tools. Often the battery compartment is used as On/Off switch, which leads to complicated mechanical solutions in order to avoid opening the battery compartment completely, but allow opening it partly for On/Off functionality.

The main disadvantage is that for battery compartments with On/Off functionality, difficult mechanical solutions are needed. Another disadvantage is that most of the locking mechanisms have to be operated with a separate tool, which must be available all the time in order to change the battery. A screw driver for example is a special tool, which is not accepted as solution in specific countries.

An object of the present invention is to solve the problem of developing difficult mechanical solutions for tamper proof_battery compartments, which often need an additional tool to be operated. In other words an object of the present invention is to allow to open completely the battery compartment and to unlock the battery without an additional tool, taking nevertheless the above mentioned problem into consideration that the battery cannot be removed by children or mentally handicapped persons.

As a consequence, the present invention proposes a smallest electronic device or a hearing instrument respectively being operated by means of a battery wherein the battery is locked in the battery compartment instead of prevent opening the compartment itself.

In other words, the battery is locked in the battery compartment which can be easily opened without the need of an additional tool to prevent the removal of the battery out of the compartment.

Specifically, the present invention refers to devices being operated by means of so called button batteries, coin cells or round cell-batteries wherein the battery is locked within the battery compartment to prevent removal.

The battery might be locked e.g. by means of at least one lock bar.

The lock bar can be either removable or can be pivotable for de-blocking the battery for removal, etc.

Of course other means can be used for locking the battery within the compartment as e.g. clamping means, engaging protections, etc.

It is also noted that although the following detailed description illustrates a BTE application, the invention can also be applied to ITE, ITC and CIC hearing devices, as well as to hearing instrument accessories such as remote microphones and remote controls, wireless communication interfaces and others.

The present invention is described in more details with reference to the attached figures, where

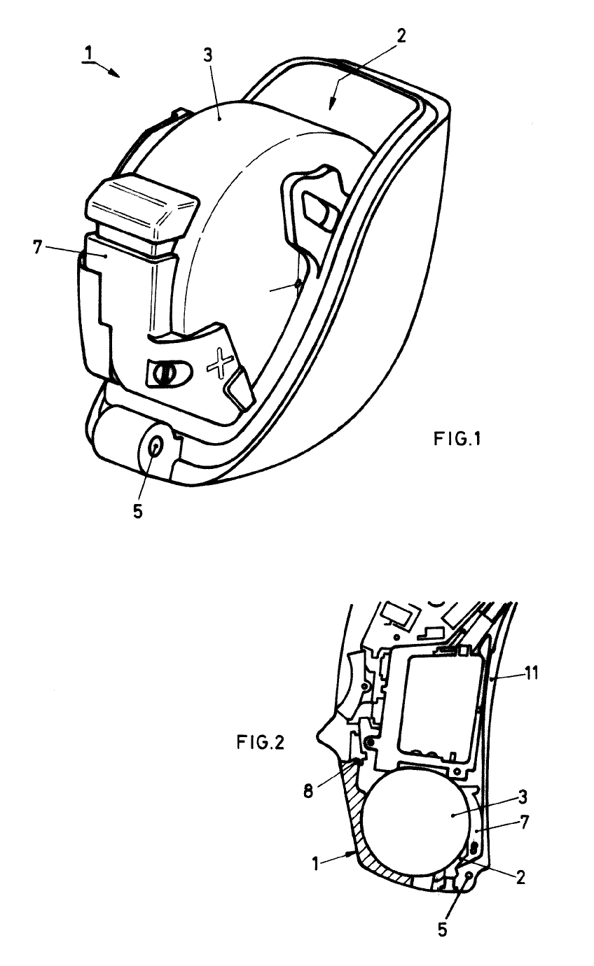

FIG. 1 shows in perspective view a battery compartment of an electronic smallest device with the battery lock in “locked” position, and

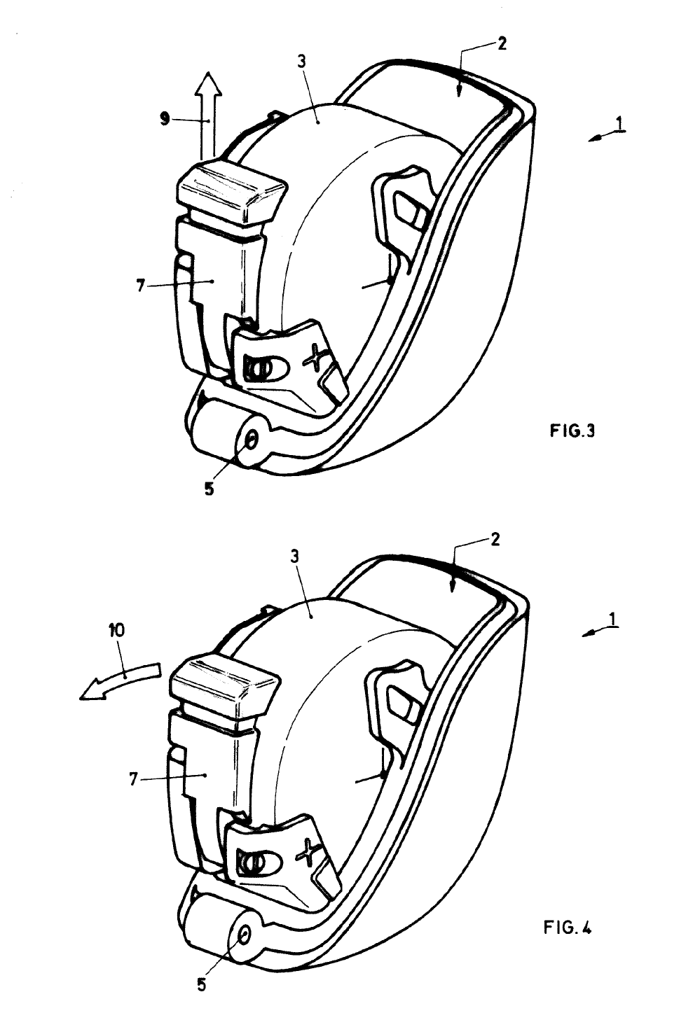

FIG. 2 shows in a sectional view part of a hearing instrument including the battery compartment.

FIG. 3 shows in perspective view a battery compartment of an electronic smallest device with the battery lock in an intermediate position.

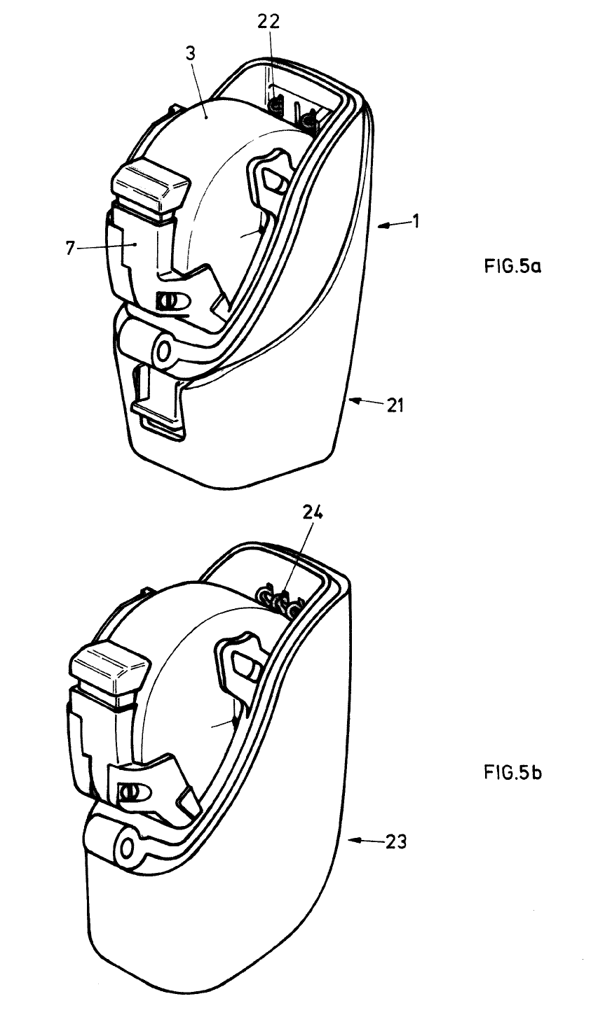

FIG. 4 shows in perspective view a battery compartment of an electronic smallest device with the battery lock in “open” position.

FIGS. 5a and 5b show in perspective view battery compartments of an electronic smallest device comprising additional functionality such as an RF receiver or a wireless communication interface or other.

FIG. 1 shows in perspective view a battery compartment 1, where within a receiving cavity 2 a button battery 3 is ranged. The battery compartment 1 can be opened out of a housing of a smallest electronic device such as a hearing instrument by pivoting around an axis 5. After opening of the compartment the battery 3 is still firmly retained within the cavity 2 by means of a locking bar 7, which means the battery is retained by means of the lock bar to prevent removal. In other words the battery 3 itself is locked in the battery compartment. The lock bar 7 can be operated for instance by means of fingers in the direction of the arrow 9. If the battery 3 has to be changed, the lock bar has to be unlocked. This solution allows opening and closing the battery compartment 1 the same way, with or without battery lock in place.

In addition, locking the battery in the battery compartment prevents loosing the battery wile opening the battery compartment. Furthermore, the battery can not easily be removed e.g. by a child or by a mentally handicapped person. In addition, tolerances of batteries are not anymore as problematic as they have been in the past. Therefore this solution according to the present invention is not only for tamper proof applications. It offers a benefit to every hearing instrument wearer and more generally to all electronic smallest devices, which are operated by means of batteries.

Furthermore, in FIG. 2 in sectional viewing part of a hearing instrument 11 is shown, including a battery compartment 1 similar to the one shown in FIG. 1. Again within the battery compartment 1 in a receiving cavity 2 a battery 3 is arranged. The battery compartment 1 can be opened by pivoting around an axis 5 and due to the arrangement of the lock bar 7 there is no danger of loosing the battery out of the compartment. In other words, for removing the battery, first the lock bar 7 has to be operated as described with reference to FIG. 1. The compartment itself can be easily opened or closed, as it is only hold by means of a mechanical catch 8 within the housing of the hearing instrument 11.

As shown in FIG. 3 the lock bar 7 can be operated e.g. by means of fingers in the direction of an arrow 9 into an intermediate position.

If the battery 3 has to be changed, the lock bar 7 is unlocked by further movement in direction of arrow 10 as shown in FIG. 4 which shows in a perspective view the battery compartment 1 of the electronic smallest device with the battery locked in “open” position.

FIGS. 5a and 5b show in perspective view battery compartments of an electronic smallest device comprising additional functionality such as e.g. a RF-Receiver 21 (FIG. 5a) or a wireless communication interface 23 (FIG. 5b). Those additional components may be connected to the electronic smallest device by connecting pins 22 or 24.

The present invention is not at all limited to the use of a lock bar, as shown with reference to FIG. 1 + 2. First of all the lock bar can be slidably arranged to lock or unlock the battery or it can be pivotably arranged for unlocking the battery or both in combination. Instead of a lock bar also clamping means can be arranged for firmly holding the battery within the compartment or elastic protections surrounding the outer surface of the battery. Still other possible means can be arranged for firmly holding the battery within the compartment.

The great advantage of the present invention is, that the introduced battery lock is robust and easy to be operated, offering enhanced ease of use and operational safety for hearing instrument users in general and for pediatric applications in particular. The lock bar can be attached to a regular battery compartment. Therefore no additional tool or no separate battery compartment is needed for tamper proof features. The idea of locking the battery in the compartment instead of developing difficult mechanical solution will be the solution for future hearing instrument battery compartments.

1. Smallest electronic device such as e.g. a hearing instrument being operated by means of a battery comprising a battery compartment (1) holding at least one battery (3) for battery supply to the device characterized in that the battery (3) is locked in the compartment to prevent removal or falling out of the battery.

2. Device according to claim 1 characterized in that the battery (3) is locked by means of at least one lock bar (3).

3. Device according to claim 2 characterized in that the lock bar is slidably or pivotably operable or both in combination to lock or unlock the battery within the compartment.

4. Device according to claim 1 characterized in that the battery is locked within the compartment by means of clamping means of elastic protecting means at least partially surrounding the outer surface of the battery.

5. Device according to one of the claims 1 to 4 characterized in that the compartment is suitable for the arrangement of button batteries, coin cells, round cell-batteries, rechargeable batteries, fuel cells etc.

6. Device according to one of the claims 1 to 5 characterized in that within the compartment or attached to it further components maybe arranged or combined with comprising additional functionality such as an RF-Receiver, a wireless communication interface, etc.
